(19) United States
(12) Patent Application Publication
(10) Pub. No.: US 2024/0178445 A1
(43) Pub. Date: May 30, 2024

(54) SULFIDE SOLID ELECTROLYTE MATERIAL, BATTERY, AND METHOD OF MANUFACTURING SULFIDE SOLID ELECTROLYTE MATERIAL

(71) Applicants: TOYOTA JIDOSHA KABUSHIKI KAISHA, Toyota-shi (JP); TOKYO INSTITUTE OF TECHNOLOGY, Tokyo (JP)

(72) Inventors: Keiichi MINAMI, Tagata-gun (JP); Ryoji KANNO, Tokyo (JP); Satoshi HORI, Tokyo (JP)

(73) Assignees: TOYOTA JIDOSHA KABUSHIKI KAISHA, Toyota-shi (JP); TOKYO INSTITUTE OF TECHNOLOGY, Tokyo (JP)

(21) Appl. No.: 18/518,741

(22) Filed: Nov. 24, 2023

(30) Foreign Application Priority Data
Nov. 25, 2022 (JP) 2022-188778

(51) Int. Cl. H01M 10/0562

(52) U.S. Cl. CPC H01M 10/0562; H01M 2004/028

(57) ABSTRACT

A sulfide solid electrolyte material contains element M₁, element M₂, element M₃ and element S. Element M₁ is at least one type selected from the group consisting of Li, Na, K, Mg Ca and Zn, and contains at least one of Li and Na. Element M₂ is at least one type selected from the group consisting of P, Sb, Si, Ge, Sn, B, Al, Ga, In, Ti, Zr and V, and contains at least P.

### CROSS-REFERENCE TO RELATED APPLICATION

This application is based on and claims priority under 35 USC 119 from Japanese Patent Application No. 2022-188778 filed on Nov. 25, 2022, the disclosure of which is incorporated by reference herein.

### BACKGROUND

### Technical Field

The present disclosure relates to a sulfide solid electrolyte material, a battery, and a method of manufacturing a sulfide solid electrolyte material.

### Related Art

Accompanying the rapid popularization of information-related devices, communication devices and the like such as personal computers, video cameras, cell phones and the like in recent years, the development of batteries that are used as the power sources thereof is regarded as important. Further, in the automotive industry and the like as well, the development of high-output, high-capacitance batteries for electric vehicles and hybrid vehicles is advancing. Among the various types of batteries, attention is currently focusing on lithium batteries from the standpoint that such batteries have high energy density.

Lithium batteries that currently are commercially available use electrolyte liquids containing flammable organic solvents. Therefore, there is the need for improvement in structures and materials for preventing short-circuiting and for mounting safety devices that suppress a rise in temperature at the time of short-circuiting. To address this, lithium batteries, which use a solid electrolyte layer instead of an electrolyte liquid and are made to be all-solid-state batteries, do not use a flammable organic solvent within the battery, and therefore, simplification of safety devices is devised, and the manufacturing cost and mass producibility are excellent.

Sulfide solid electrolyte materials are known as solid electrolyte materials that are used in all-solid-state lithium batteries.

For example, International Publication No. 2011/118801 discloses an LiGePS-based sulfide solid electrolyte material having specific peaks in X-ray diffraction measurement.

Japanese Patent Application Laid-Open (JP-A) No. 2014-137918 discloses a sulfide solid electrolyte material containing element M₁, element M₂ and the element S, wherein M₁ is a combination of Li and at least one type of bivalent element selected from the group consisting of Mg, Ca and Zn, and M₂ is at least one type selected from the group consisting of P, Sb, Si, Ge, Sn, B, Al, Ga, In, Ti, Zr, V and Nb.

JP-A No. 2013-149599 discloses a sulfide solid electrolyte material containing element M₁, element M₂, the element S and the element O, wherein M₁ contains at least Li, and M₂ is at least one type selected from the group consisting of P, Sb, Si, Ge, Sn, B, Al, Ga, In, Ti, Zr, V and Nb.

JP-A No. 2015-069696 discloses a sulfide solid electrolyte material containing the element Li, element Me (Me is at least one type selected from the group consisting of Sb, Si, Ge, Sn, B, Al, Ga, In, Ti, Zr, V and Nb), the element P, and the element S.

### SUMMARY

An aspect of the present disclosure is a sulfide solid electrolyte material, comprising an element M₁, an element M₂, an element M₃ and an element S, wherein: the element M₁ is at least one selected from the group consisting of Li, Na, K, Mg, Ca and Zn, and contains at least one of Li or Na; the element M₂ is at least one selected from the group consisting of P, Sb, Si, Ge, Sn, B, Al, Ga, In, Ti, Zr and V, and contains at least P; the element M₃ is at least one selected from transition elements of group 3 to group 12; and the sulfide solid electrolyte material has a peak at a position of 2θ=29.58°±0.50°, in X-ray diffraction measurement using a CuKα beam, or the sulfide solid electrolyte material does not have a peak at a position of 2θ=27.33°±0.50°, in X-ray diffraction measurement using a CuKα beam, or in a case in which the sulfide solid electrolyte material has a peak at a position of 2θ=27.33°±0.50°, if a diffracted intensity of the peak at 2θ=29.58°±0.50° is I_{A} and a diffracted intensity of the peak at 2θ=27.33°±0.50° is I_{B}, a value of I_{B}/I_{A} is less than 1.00.

### BRIEF DESCRIPTION OF THE DRAWINGS

FIG. 1 is X-ray diffraction spectra for explaining the difference between a sulfide solid electrolyte material having high ion conductivity and a sulfide solid electrolyte material having low ion conductivity;

FIG. 2 is a perspective view for explaining an example of the crystal structure of a sulfide solid electrolyte material of the present disclosure;

FIG. 3 is a plan view for explaining ion conduction in the present disclosure;

FIG. 4 is a schematic sectional view illustrating an example of a battery of the present disclosure; and

FIG. 5 is an explanatory drawing illustrating an example of a method of manufacturing the sulfide solid electrolyte material of the present disclosure.

### DETAILED DESCRIPTION

The sulfide solid electrolyte material, battery, and method of manufacturing a sulfide solid electrolyte material of the present disclosure are described in detail hereinafter.

### A. Sulfide Solid Electrolyte Material

First, the sulfide solid electrolyte material of the present disclosure is described. The sulfide solid electrolyte material of the present disclosure can be broadly classified into two embodiments thereof. Thus, a first embodiment and a second embodiment of the sulfide solid electrolyte material of the present disclosure will be described separately.

### 1. First Embodiment

The sulfide solid electrolyte material of the first embodiment contains element M₁, element M₂, element M₃ and the element S, wherein element M₁ is at least one type selected from the group consisting of Li, Na, K, Mg, Ca and Zn and contains at least one of Li and Na, and element M₂ is at least one type selected from the group consisting of P, Sb, Si, Ge, Sn, B, Al, Ga, In, Ti, Zr and V and contains at least P, and element M₃ is at least one type selected from transition elements of group 3˜group 12, and the sulfide solid electrolyte material has a peak at a position of 2θ=29.58°±0.50° in X-ray diffraction measurement using a CuKα beam, and the sulfide solid electrolyte material does not have a peak at a position of 2θ=27.33°±0.50° in X-ray diffraction measurement using a CuKα beam, or, if the sulfide solid electrolyte material does have a peak at a position of 2θ=27.33°±0.50°, given that the diffracted intensity of the peak at 2θ=29.58°±0.50° is IA and the diffracted intensity of the peak at 2θ=27.33°±0.50° is I_{B}, the value of I_{B}/I_{A} is less than 1.00.

In accordance with the first embodiment, there can be provided a sulfide solid electrolyte material exhibiting excellent water resistance even in an environment in which the moisture concentration is high (e.g., a dewpoint of −6° C.). The reason for this is surmised to be as follows.

With conventional sulfide solid electrolyte materials as well, if the environment to which the material is exposed is a dry environment (e.g., a dewpoint of −30° C.), hardly any H₂S is generated, and the water resistance is not problematic. However, H₂S is generated in environments that approximate actual use, i.e., in environments in which the moisture concentration is high (e.g., a dewpoint of −6° C.). It is thought that this is because, in an environment in which the moisture concentration is high, the speed of the reaction with the moisture increases, and the reaction proceeds to as far as within the bulk. Thus, there is the need for improvement in the water resistance of sulfide solid electrolyte materials.

In regard to this point, the present inventors studied elemental compositions of sulfide solid electrolyte materials that could improve water resistance. As a result, it is found that, by including a transition element that forms a stable sulfide in atmosphere, the amount of H₂S that is generated can be suppressed even in a case of exposure to an environment in which the moisture concentration is high (e.g., an environment of a dewpoint of −6° C. in which the moisture content is as much as 10 times that of an environment in which the dewpoint is −30° C.).

This is thought to be because element M₃ (i.e., a transition element) concentrates at the surface of the sulfide and forms a stable sulfide in atmosphere, and the reaction with moisture is suppressed.

Due to the above, in accordance with the first embodiment, there can be provided a sulfide solid electrolyte material that exhibits excellent water resistance even in an environment in which the moisture concentration is high (e.g., a dewpoint of −6° C.).

Note that, in the sulfide solid electrolyte material of the first embodiment, the proportion of the crystal phase having a peak in the vicinity of 2θ=29.58° is high, and therefore, the ion conductivity is excellent. Thus, a high-output battery can be obtained by using the sulfide solid electrolyte material of the first embodiment.

### Peaks

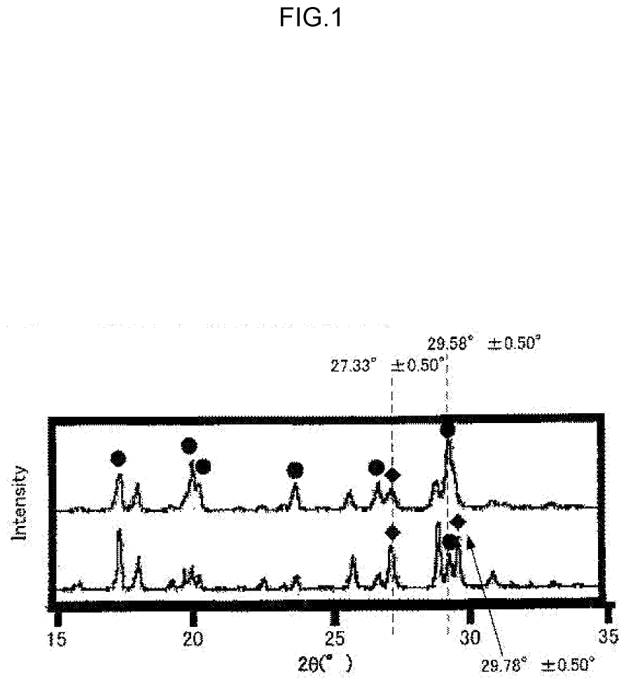

FIG. 1 is X-ray diffraction spectra for explaining the difference between a sulfide solid electrolyte material having high ion conductivity (the spectrum at the top) and a sulfide solid electrolyte material having low ion conductivity (the lower spectrum). Note that the two sulfide solid electrolyte materials in FIG. 1 both have an Li_{3.25}Ge_{0.25}P_{0.75}S₄ composition. In FIG. 1, the sulfide solid electrolyte material of high ion conductivity has peaks at a position of 2θ=29.58°±0.50° and at a position of 2θ=27.33°±0.50°. Further, in FIG. 1, the sulfide solid electrolyte material of low ion conductivity has similar peaks. Here, the crystal phase that has the peak in the vicinity of θ=29.58° and the crystal phase that has the peak in the vicinity of 2θ=27.33° are thought to be crystal phases that are different from one another. Note that, in the first embodiment, there are cases in which the crystal phase having the peak in the vicinity of 2θ=29.58° is called “crystal phase A”, and the crystal phase having the peak in the vicinity of 2θ=27.33° is called “crystal phase B”. Note that, as will be described later, the sulfide solid electrolyte material having high ion conductivity has a crystal structure that is similar to that of the sulfide solid electrolyte material of the first embodiment.

Crystal phases A, B both are crystal phases exhibiting ion conductivity, but there is a difference in the ion conductivities thereof. Crystal phase A is thought to have a markedly higher ion conductivity than crystal phase B. In conventional synthesizing methods (e.g., the solid phase method), the proportion of crystal phase B having low ion conductivity could not be made to be small, and the ion conductivity could not be made to be sufficiently high. In contrast, in the first embodiment, because crystal phase A that has a high ion conductivity can be actively precipitated, a sulfide solid electrolyte material having high ion conductivity can be obtained.

Further, in the first embodiment, in order to differentiate from the sulfide solid electrolyte material that has low ion conductivity, the diffracted intensity of the peak in the vicinity of 2θ=29.58° is I_{A}, the diffracted intensity of the peak in the vicinity of 2θ=27.33° is I_{B}, and the value of I_{B}/I_{A} is prescribed as less than 1.00. Note that it is thought that a sulfide solid electrolyte material in which the value of I_{B}/I_{A} is less than 1.00 cannot be obtained by a conventional synthesizing method. Further, from the standpoint of ion conductivity, it is preferable that, in the sulfide solid electrolyte material of the first embodiment, the proportion of crystal phase A that has high ion conductivity is high. Therefore, it is preferable that the value of I_{B}/I_{A} is small. Specifically, the value of I_{B}/I_{A} is preferably 0.50 or less, and more preferably 0.45 or less, and even more preferably 0.25 or less, and still more preferably 0.15 or less, and even more preferably 0.07 or less. Further, it is preferable that the value of I_{B}/I_{A} is 0. In other words, it is preferable that the sulfide solid electrolyte material of the first embodiment not have a peak in the vicinity of 2θ=27.33° that is the peak of crystal phase B.

The sulfide solid electrolyte material of the first embodiment has a peak in the vicinity of 2θ=29.58°. As described above, this peak is one peak of crystal phase A that has high ion conductivity. Here, 2θ=29.58° is an actually measured value, and the crystal lattice varies slightly depending on the material composition and the like, and there are cases in which the position of the peak is shifted slightly from 2θ=29.58°. Therefore, in the first embodiment, this peak of crystal phase A is defined as a peak of a position of 29.58°±0.50°. Usually, crystal phase A is thought to have peaks of 2θ=17.38°, 20.18°, 20.44°, 23.56°, 23.96°, 24.93°, 26.96°, 29.07°, 29.58°, 31.71°, 32.66°, 33.39°. Note that there are cases in which these peak positions as well are shifted within ranges of ±0.50°.

On the other hand, as described above, the peak that is in the vicinity of 2θ=27.33° is one peak of crystal phase B that has low ion conductivity. Here, 2θ=27.33° is an actually measured value, and the crystal lattice varies slightly depending on the material composition and the like, and there are cases in which the position of the peak is shifted slightly from 2θ=27.33°.

Therefore, in the first embodiment, this peak of crystal phase B is defined as a peak of a position of 27.33°±0.50°. Usually, crystal phase B is thought to have peaks of 2θ=17.46°, 18.12°, 19.99°, 22.73°, 25.72°, 27.33°, 29.16°, 29.78°. Note that there are cases in which these peak positions as well are shifted within ranges of ±0.50°.

### Elements

The sulfide solid electrolyte material of the first embodiment contains element M₁, element M₂, element M₃ and the element S.

Element M₁ is at least one type selected from the group consisting of Li, Na, K, Mg, Ca and Zn, and contains at least one of Li and Na. Namely, only one of Li and Na, or both Li and Na, may be contained as element M₁. Further, the element M₁ may be a combination of, in addition to at least one of Li and Na, at least one type selected from the group consisting of K, Mg, Ca and Zn.

Element M₂ is at least one type selected from the group consisting of P, Sb, Si, Ge, Sn, B, Al, Ga, In, Ti, Zr and V, and contains at least P. Namely, element M₂ may be only P, or may be a combination of, in addition to P, at least one type selected from the group consisting of Sb, Si, Ge, Sn, B, Al, Ga, In, Ti, Zr and V. Thereamong, in the first embodiment, element M₂ preferably contains at least P and at least one type selected from the group consisting of Si, Ge, Al, Zr, Sn and B, and even more preferably contains at least P and Ge, or at least P and Si.

Element M3 is at least one type selected from transition elements of group 3˜group 12. Namely, an element from Sc, which is the element in group 3 and period 4, to Cn, which is the element in group 12 and period 7, in the periodic table is contained as element M₃. In the first embodiment, due to a transition element being contained as element M₃, excellent water resistance even in an environment in which the moisture concentration is high (e.g., a dewpoint of −6° C.) is achieved.

Thereamong, in the first embodiment, it is preferable that element M₃ include at least one type selected from transition elements of group 5˜group 6, from the standpoint of improving the water resistance in an environment in which the moisture concentration is high. Moreover, it is preferable that element M₃ include at least one type selected from the group consisting of Ta, Nb and W, and even more preferable that element M₃ include at least one type selected from the group consisting of Nb and W.

The proportion (M₃/M₂) of the content of element M₃ with respect to the content of element M₂ is preferably 0.010˜0.040, and more preferably 0.015˜0.035. Due to the proportion (M₃/M₂) being in the above range, both high ion conductivity and excellent water resistance in an environment in which the moisture concentration is high (e.g., a dewpoint of −6° C.) are achieved.

Moreover, the sulfide solid electrolyte material of the first embodiment contains the element S.

In the Examples that are described hereinafter, sulfide solid electrolyte materials containing Ta, Nb or W in addition to LiGePS-based elements are actually synthesized, and X-ray diffraction measurement of the obtained samples is carried out, and it is confirmed that I_{B}/I_{A} is a predetermined value or less. In the sulfide solid electrolyte materials of the Examples that are described hereinafter, element M₁ is the element Li, element M₂ is the element Ge or the element P, and element M₃ corresponds to the element Ta, the element Nb or the element W.

On the other hand, the sulfide solid electrolyte material of the first embodiment usually has a specific crystal structure that is described in the second embodiment described hereinafter. It is assumed that, with arbitrary combinations of element M₁ and element M₂, similar crystal structures will be obtained in LiGePS-based sulfide solid electrolyte materials. Therefore, it is thought that, with arbitrary combinations of element M₁ and element M₂, sulfide solid electrolyte materials having good ion conductivity will be obtained in any case. Further, because the positions of the peaks of the X-ray diffraction depend on the crystal structure, it is thought that, if sulfide solid electrolyte materials have the above-described crystal structure, similar XRD patterns will be obtained regardless of the types of element M₁ and element M₂.

It is preferable that the sulfide solid electrolyte material of the first embodiment contains the element Li, the element Ge, the element P, the element S, and element M₃.

In the first embodiment, the composition of the sulfide solid electrolyte material that contains element M₃ in addition to LiGePS-based elements is not particularly limited provided that it is a composition by which a predetermined value of I_{B}/I_{A} can be obtained, and is preferably a composition in which the ratio of [Li], [element M₃], [Ge], [P] and [S] is [Li]₍₄₋ₓ₎[element M₃], [Ge]₍₁₋ₓ₎[P]ₓ[S]₄ (x satisfies 0<x<1, y satisfies 0.010≤y≤0.040). Due to this composition being satisfied, both high ion conductivity and excellent water resistance in an environment in which the moisture concentration is high (e.g., a dewpoint of −6° C.) can be achieved.

Here, composition Li₍₄₋ₓ₎Ge₍₁₋ₓ₎PₓS₄ that does not have element M₃ corresponds to the composition of a solid solution of Li₃PS₄ and Li₄GeS₄. Namely, this composition corresponds to a composition on a tie line of Li₃PS₄ and Li₄GeS₄. Note that both Li₃PS₄ and Li₄GeS₄ correspond to ortho compositions and have the advantage of having high chemical stability. Such a sulfide solid electrolyte material having the composition Li₍₄₋ₓ₎Ge₍₁₋ₓ₎PₓS₄ is conventionally known as thio-LISICON, and the sulfide solid electrolyte material of the first embodiment may, in terms of composition, be the same as a conventional thio-LISICON. However, as described above, the proportion of the crystal phases included in the sulfide solid electrolyte material of the first embodiment are completely different from the proportion of crystal phases in conventional structures. Moreover, because the sulfide solid electrolyte material of the first embodiment contains element M₃, it has the advantage of having excellent water resistance in an environment in which the moisture concentration is high (e.g., a dewpoint of −6° C.).

Further, the x in [Li]₍₄₋ₓ₎[element M₃]_{y}[Ge]₍₁₋ₓ₎[P]ₓ[S]₄ is not particularly limited provided that it is a value by which a predetermined value of I_{B}/I_{A} can be obtained, and, for example, preferably satisfies 0.4≤x, and more preferably satisfies 0.5≤x. On the other hand, x preferably satisfies x≤0.8, and more preferably satisfies x≤0.75. This is because, due to x being in such a range, the value of I_{B}/I_{A} can be made to be smaller.

Further, it is preferable that the sulfide solid electrolyte material of the first embodiment be a material formed by using at least Li₂S, P₂S₅ and GeS₂.

Further, it is preferable that the sulfide solid electrolyte material of the first embodiment contains at least the element Li, the element Si, the element P, the element S, and element M₃.

In the first embodiment, the composition of the sulfide solid electrolyte material that contains element M₃ in addition to LiSiPS-based elements is not particularly limited provided that it is a composition by which a predetermined value of I_{B}/I_{A} can be obtained, and is preferably a composition in which the ratio of [Li], [element M₃], [Si], [P] and [S] is [Li]₍₄₋ₓ₎[element M₃]_{y}[Si]₍₁₋ₓ₎[P]ₓ[S]₄ (x satisfies 0<x<1, y satisfies 0.010≤y≤0.040). Due to this composition being satisfied, both high ion conductivity and excellent water resistance in an environment in which the moisture concentration is high (e.g., a dewpoint of −6° C.) can be achieved. Here, the composition Li₍₄₋ₓ₎Ge₍₁₋ₓ₎PₓS₄ that does not have element M₃ corresponds to the composition of a solid solution of Li₃PS₄ and Li₃GeS₄. Namely, this composition corresponds to a composition on a tie line of Li₃PS₄ and Li₃GeS₄. Note that both Li₃PS₄ and Li₄GeS₄ correspond to ortho compositions and have the advantage of having high chemical stability.

Further, the x in [Li]₍₄₋ₓ₎[element M₃], [Si]₍₁₋ₓ₎[P]ₓ[S]₄ is not particularly limited provided that it is a value by which a predetermined value of I_{B}/I_{A} can be obtained, and, for example, preferably satisfies 0.4≤x, and more preferably satisfies 0.5≤x. On the other hand, x preferably satisfies x≤0.8, and more preferably satisfies x≤0.75. This is because, due to x being in such a range, the value of I_{B}/I_{A} can be made to be smaller.

Further, it is preferable that the sulfide solid electrolyte material of the first embodiment be a material formed by using at least Li₂S, P₂S₅ and SiS₂.

The sulfide solid electrolyte material of the first embodiment is usually a crystalline sulfide solid electrolyte material. Further, the sulfide solid electrolyte material of the first embodiment preferably has high ion conductivity. The ion conductivity of the sulfide solid electrolyte material at 25° C. is preferably 1.0×10⁻³ S/cm or more, and more preferably 2.3×10⁻³ S/cm or more. Further, the form of the sulfide solid electrolyte material of the first embodiment is not particularly limited, and the form of a powder is an example thereof. The average particle diameter of the sulfide solid electrolyte material that is in a powder form is preferably, for example, within the range of 0.1 μm˜50 μm.

The sulfide solid electrolyte material of the first embodiment can be used in arbitrary applications. Thereamong, the sulfide solid electrolyte material of the first embodiment is preferably used in batteries. This is because the sulfide solid electrolyte material can greatly contribute to making batteries have higher output. Further, the method of manufacturing the sulfide solid electrolyte material of the first embodiment is described in detail in following “C. Method of Manufacturing Sulfide Solid Electrolyte Material”. The sulfide solid electrolyte material of the first embodiment may also possess features of the second embodiment that is described later.

Note that, in the first embodiment, there can be provided a sulfide solid electrolyte material that has a peak at a position of 2θ=29.58°±0.50° in X-ray diffraction measurement using a CuKα beam, and does not have a peak at a position of 2θ=27.33°±0.50° in X-ray diffraction measurement using a CuKα beam, or, if the sulfide solid electrolyte material does have a peak at a position of 2θ=27.33°±0.50°, given that the diffracted intensity of the peak at 2θ=29.58°±0.50° is I_{A} and the diffracted intensity of the peak at 2θ=27.33°±0.50° is I_{B}, the value of I_{B}/I_{A} is less than 1.00. The inclusion of a case in which the sulfide solid electrolyte material of the first embodiment does not have a peak in the vicinity of 2θ=27.33° that is the peak of crystal phase B is clear from the above explanation. However, by this expression, the case in which the sulfide solid electrolyte material does not have a peak in the vicinity of 2θ=27.33° can be prescribed more clearly.

### 2. Second Embodiment

A second embodiment of the sulfide solid electrolyte material of the present disclosure is described next. The sulfide solid electrolyte material of the second embodiment contains octahedrons O structured from element M₁ and the element S, tetrahedrons T₁ structured from element M₂ₐ and the element S, and tetrahedrons T₂ structured from the element S and at least one type selected from the group consisting of element M_{2b} and element M₃, and includes, as the main body thereof, a crystal structure in which the tetrahedrons T₁ and the octahedrons O share edges and the tetrahedrons T₂ and the octahedrons O share vertices, wherein element M₁ is at least one type selected from the group consisting of Li, Na, K, Mg, Ca and Zn and contains at least one of Li and Na, and element M₂ₐ and element M_{2b} respectively and independently are at least one type selected from the group consisting of P, Sb, Si, Ge, Sn, B, Al, Ga, In, Ti, Zr and V and contain at least P, and element M₃ is at least one type selected from transition elements of group 3˜group 12.

In accordance with the second embodiment, there can be provided a sulfide solid electrolyte material exhibiting excellent water resistance even in an environment in which the moisture concentration is high (e.g., a dewpoint of −6° C.

The present inventors found that, by including a transition element, which forms a stable sulfide in atmosphere, in a sulfide solid electrolyte material, the amount of H₂S that is generated can be suppressed even in a case of exposure to an environment in which the moisture concentration is high (e.g., an environment of a dewpoint of −6° C. in which the moisture content is as much as 10 times that of an environment in which the dewpoint is −30° C.).

This is thought to be because element M₃ (i.e., a transition element) concentrates at the surface of the sulfide and forms a stable sulfide in atmosphere, and the reaction with moisture is suppressed.

In accordance with the second embodiment, because the octahedrons O, the tetrahedrons T₁ and the tetrahedrons T₂ have a predetermined crystal structure (three-dimensional structure), a sulfide solid electrolyte material having good ion conductivity can be obtained. In at least one of the octahedrons O, tetrahedrons T₁ and tetrahedrons T₂, some of the element S is substituted with element O, and therefore, a sulfide solid electrolyte material having even better ion conductivity can be obtained. Therefore, by using the sulfide solid electrolyte material of the second embodiment, a high-output battery can be obtained.

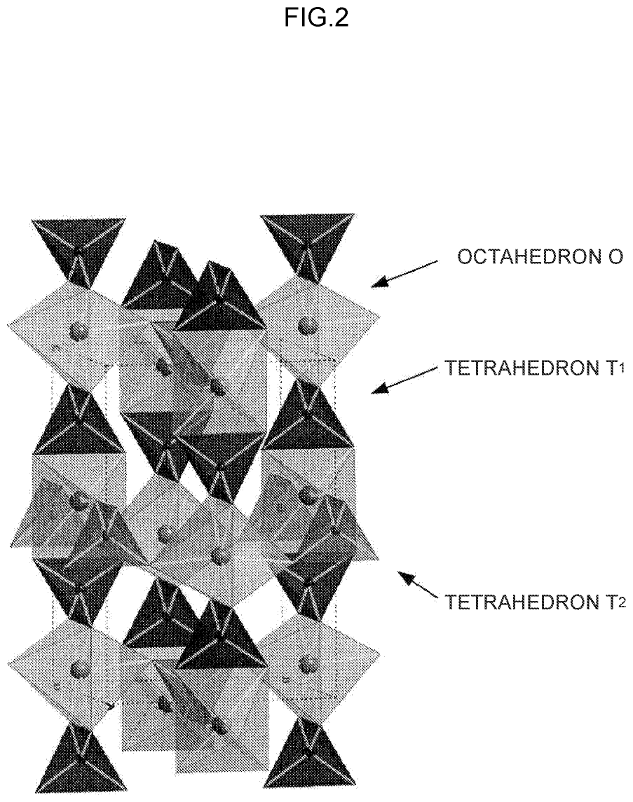

FIG. 2 is a perspective view for explaining an example of the crystal structure of the sulfide solid electrolyte material of the second embodiment. In the crystal structure illustrated in FIG. 2, the octahedron O has M₁ as the central element, has six S at vertices of the octahedron, and is typically a LiS₆ octahedron. The tetrahedron T₁ has M₂ₐ as the central element, has four S at vertices of the tetrahedron, and is typically both a GeS₄ tetrahedron and a PS₄ tetrahedron. The tetrahedron T₂ has M_{2b} as the central element (note that some of the M_{2b} may be substituted with M₃), has four S at the vertices of the tetrahedron, and is typically a PS₄ tetrahedron and an [M_{3]}S₄ tetrahedron (M₃ is, for example, Ta, Nb, W or the like). In the sulfide solid electrolyte material of the second embodiment, in at least some of the tetrahedrons T₂, some of the element M_{2b} is substituted by element M₃. Note that some of the element M_{2b} being substituted by element M₃ can be confirmed by, for example, analysis of the XRD pattern by the Rietveld method, neutron diffraction, or the like. Moreover, the tetrahedrons T₁ and the octahedrons O share edges, and the tetrahedrons T₂ and the octahedrons O share vertices.

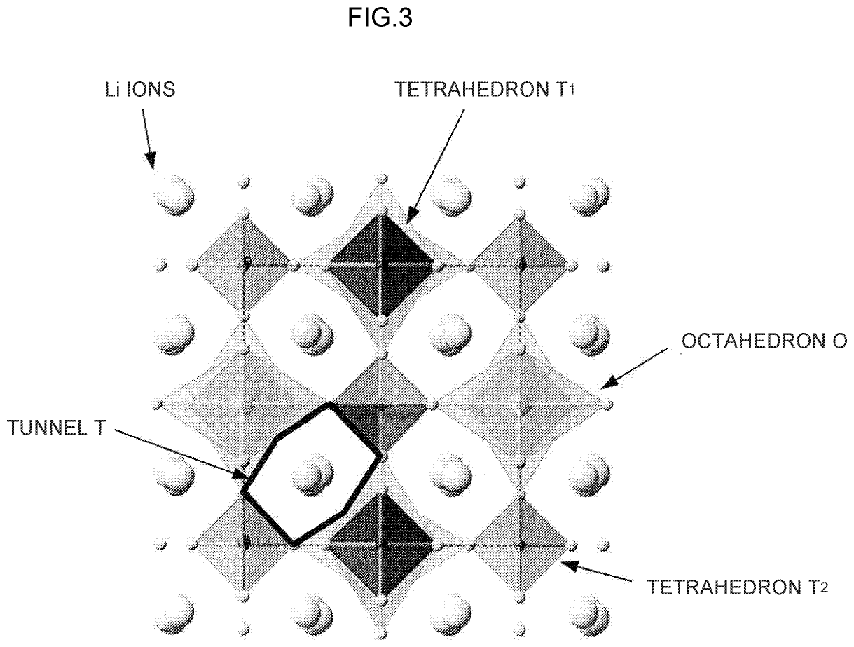

FIG. 3 is a plan view for explaining ion conduction in the second embodiment. In FIG. 3, Li ions are conducted, in the c-axis direction (the direction orthogonal to the surface of FIG. 3), through the interior (tunnels T) of the crystal structure that is structured from the octahedrons O, the tetrahedrons T₁ and the tetrahedrons T₂. Note that the Li ions are disposed in a slightly zigzag manner. The size of the tunnels T is determined by the sizes of the vertex elements and the central elements of the respective polyhedrons. In the second embodiment, it is thought that, by substituting some of the element S that is the vertex element of the polyhedrons with the element O that is small-sized, a tunnel size at which Li ions are easily conducted is formed, and the ion conductivity of the sulfide solid electrolyte material improves.

The sulfide solid electrolyte material of the second embodiment has the above-described crystal structure as the main body thereof. The proportion of the above-described crystal structure in the entire crystal structure of the sulfide solid electrolyte material is not particularly limited, but is preferably higher. This is because a sulfide solid electrolyte material of a high ion conductivity can be obtained. Specifically, the proportion of the above-described crystal structure is preferably 70 mass % or more, and more preferably 90 mass % or more. Note that the proportion of the above-described crystal structure can be measured by radiation XRD for example. In particular, the sulfide solid electrolyte material of the second embodiment is preferably a single-phase material of the above-described crystal structure. This is because the ion conductivity can be made to be extremely high.

Note that element M₁, elements M₂ (element M₂ₐ, element M_{2b}), element M₃, and other points in the second embodiment are the same as those of the above-described first embodiment, and therefore, description thereof is omitted here.

### B. Battery

The battery of the present disclosure is described next. The battery of the present disclosure is a battery including a positive electrode active material layer containing a positive electrode active material, a negative electrode active material layer containing a negative electrode active material, and an electrolyte layer formed between the positive electrode active material layer and the negative electrode active material layer, wherein at least one of the positive electrode active material layer, the negative electrode active material layer and the electrolyte layer contains the above-described sulfide solid electrolyte material.

In accordance with the present disclosure, a high-output battery can be obtained by using the above-described sulfide solid electrolyte material.

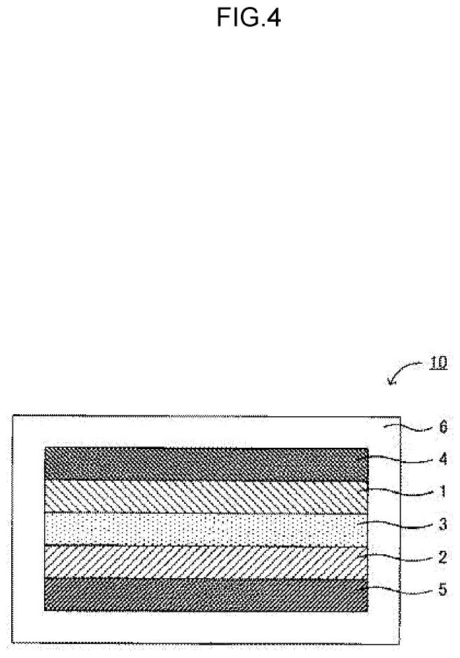

FIG. 4 is a schematic sectional view illustrating an example of the battery of the present disclosure. Battery 10 in FIG. 4 has a positive electrode active material layer 1 containing a positive electrode active material, a negative electrode active material layer 2 containing a negative electrode active material, an electrolyte layer 3 formed between the positive electrode active material layer 1 and the negative electrode active material layer 2, a positive electrode collector 4 carrying out power collection of the positive electrode active material layer 1, a negative electrode collector 5 carrying out power collection of the negative electrode active material layer 2, and a battery case 6 that houses these members. A major feature of the present disclosure is that at least one of the positive electrode active material layer 1, the negative electrode active material layer 2 and the electrolyte layer 3 contains the sulfide solid electrolyte material that was described in above “A. Sulfide Solid Electrolyte Material”.

The respective structures of the battery of the present disclosure are described hereinafter one-by-one.

### 1. Electrolyte Layer

The electrolyte layer in the present disclosure is a layer formed between the positive electrode active material layer and the negative electrode active material layer. The electrolyte layer is not particularly limited provided that it is a layer that can carry out conduction of ions, but preferably is a solid electrolyte layer formed from a solid electrolyte material. This is because, as compared with a battery that uses an electrolyte liquid, a highly-stable battery can be obtained. Moreover, in the present disclosure, it is preferable that the solid electrolyte layer contain the above-described sulfide solid electrolyte material. The proportion of the above-described sulfide solid electrolyte material contained in the solid electrolyte layer is, for example, in the range of 10 vol %˜100 vol %, and therein, is preferably in the range of 50 vol %˜100 vol %. In particular, in the present disclosure, it is preferable that the solid electrolyte layer be formed from only the above-described sulfide solid electrolyte material. This is because a high-output battery can be obtained. The thickness of the solid electrolyte layer is, for example, in the range of 0.1 μm˜1000 μm, and therein, is preferably in the range of 0.1 μm˜100 μm. Further, examples of the method of forming the solid electrolyte layer are a method of compression molding a solid electrolyte material, and the like.

The electrolyte layer in the present disclosure may be a layer formed from an electrolyte liquid. In a case of using an electrolyte liquid, as compared with a case in which a solid electrolyte layer is used, safety must be additionally taken into consideration, but a battery of a higher output can be obtained. Further, in this case, usually, at least one of the positive electrode active material layer and the negative electrode active material layer contains the above-described sulfide solid electrolyte material. The electrolyte liquid usually contains a lithium salt and an organic solvent (a nonaqueous solvent). Examples of the lithium salt are inorganic lithium salts such as LiPF₆, LiBF₄, LiClO₄, LiAsF₆ and the like, and organic lithium ion salts such as LiCF₃SO₃, LIN(CF₃SO₂)₂, LIN(C₂F₅SO₂)₂, LiC(CF₃SO₂)₃ and the like, and the like. Examples of the organic solvent are ethylene carbonate (EC), propylene carbonate (PC), dimethyl carbonate (DMC), diethyl carbonate (DEC), ethyl methyl carbonate (EMC), butylene carbonate (BC) and the like.

### 2. Positive Electrode Active Material Layer

The positive electrode active material layer in the present disclosure is a layer containing at least a positive electrode active material, and, as needed, may contain at least one of the a solid electrolyte material, a conductive material, and a binder. In particular, in the present disclosure, the positive electrode active material layer contains a solid electrolyte material, and it is preferable that this solid electrolyte material is the above-described sulfide solid electrolyte material. This is because a positive electrode active material layer having high ion conductivity can be obtained. The proportion of the above-described sulfide solid electrolyte material contained in the positive electrode active material layer differs depending on the type of battery, and is, for example, in the range of 0.1 vol %˜80 vol %, and therein, is preferably in the range of 1 vol %˜60 vol %, and particularly preferably in the range of 10 vol %˜50 vol %. Examples of the positive electrode active material are LiCoO₂, LiMnO₂, Li₂NiMn₃O₈, LiVO₂, LiCrO₂, LiFePO₄, LiCoPO₄, LiNiO₂, LiNi_{1/3}Co_{1/3}Mn_{1/3}O₂ and the like.

The positive electrode active material layer in the present disclosure may further contain a conductive material. The conductivity of the positive electrode active material layer can be improved due to the addition of a conductive material. Examples of the conductive material are acetylene black, ketjen black, carbon fibers, and the like. Further, the positive electrode active material layer may contain a binder. Examples of types of binders are fluorine-containing binders such as polytetrafluoroethylene (PTFE) and the like, and the like. Further, the thickness of the positive electrode active material layer is preferably within the range of 0.1 μm˜1000 μm.

### 3. Negative Electrode Active Material Layer

The negative electrode active material layer in the present disclosure is described next. The negative electrode active material layer in the present disclosure is a layer containing at least a negative electrode active material, and, as needed, may contain at least one of a solid electrolyte material, a conductive material, and a binder. In particular, in the present disclosure, the negative electrode active material layer contains a solid electrolyte material, and it is preferable that this solid electrolyte material is the above-described sulfide solid electrolyte material. This is because a negative electrode active material layer having high ion conductivity can be obtained. The proportion of the above-described sulfide solid electrolyte material contained in the negative electrode active material layer differs depending on the type of battery, and is, for example, in the range of 0.1 vol %˜80 vol %, and therein, is preferably in the range of 1 vol %˜60 vol %, and particularly preferably in the range of 10 vol %˜50 vol %. Examples of the negative electrode active material are metal active materials and carbon active materials. Examples of the metal active materials are In, Al, Si, Sn and the like. On the other hand, examples of the carbon active materials are mesocarbon microbeads (MCMB), highly oriented pyrolytic graphite (HOPG), hard carbon, soft carbon and the like. Note that conductive materials and binders that are used in the negative electrode active material layer are the same as those of the above-described positive electrode active material layer. The thickness of the negative electrode active material layer is preferably within the range of, for example, 0.1 μm˜1000 μm.

### 4. Other Structures

The battery of the present disclosure has at least the above-described electrolyte layer, positive electrode active material layer and negative electrode active material layer. Moreover, usually, the battery has a positive electrode collector carrying out power collection of the positive electrode active material layer, and a negative electrode collector carrying out power collection of the negative electrode active material layer. Examples of materials of the positive electrode collector are SUS, aluminum, nickel, iron, titanium, carbon and the like, and thereamong, SUS is preferable. On the other hand, examples of the negative electrode collector are SUS, copper, nickel, carbon and the like, and thereamong, SUS is preferable. It is preferable to appropriately select the thicknesses and the forms and the like of the positive electrode collector and the negative electrode collector in accordance with the intended use of the battery and the like. Further, a battery case for a general battery can be used as the battery case that is used in the present disclosure. Examples of the battery case are a battery case made of SUS, and the like.

### 5. Battery

The battery of the present disclosure may be a primary battery or may be a secondary battery, and, thereamong, is preferably a secondary battery. This is because repeated charging and discharging thereof are possible, and the battery is useful as a battery for a vehicle for example. Examples of the form of the battery of the present disclosure are coin-shaped, laminated, cylindrical, square and the like. Further, the method of manufacturing the battery of the present disclosure is not particularly limited provided that it is a method by which the above-described battery can be obtained, and a method similar to a general method of manufacturing a battery can be used. For example, in a case in which the battery of the present disclosure is an all-solid-state battery, an example of the manufacturing method thereof is a method in which a power generating element is fabricated by successively pressing a material structuring the positive electrode active material layer, a material structuring the solid electrolyte layer and a material structuring the negative electrode active material layer, and this power generating element is housed within a battery case, and the battery case is crimped, or the like.

### C. Method of Manufacturing Sulfide Solid Electrolyte Material

The method of manufacturing the sulfide solid electrolyte material of the present disclosure is described next. The method of manufacturing a sulfide solid electrolyte material of the present disclosure can be broadly classified into two embodiments. Thus, a first embodiment and a second embodiment of the method of manufacturing a sulfide solid electrolyte material of the present disclosure will be described separately.

### 1. First Embodiment

The method of manufacturing a sulfide solid electrolyte material of the first embodiment is a method of manufacturing the sulfide solid electrolyte material described in “A. Sulfide Solid Electrolyte Material, 1. First Embodiment”, and has the feature of including: an ion conductive material synthesizing step of synthesizing, by mechanical milling, an amorphized, ion conductive material by using a raw material composition containing above-described element M₁, element M₂, element M₃ and element S; and a heating step of obtaining the sulfide solid electrolyte material by heating the amorphized, ion conductive material.

In accordance with the first embodiment, by carrying out amorphization in the ion conductive material synthesizing step and thereafter carrying out the heating step, a sulfide solid electrolyte material having a high proportion of a crystal phase having a peak in the vicinity of 2θ=29.58° can be obtained. Therefore, a sulfide solid electrolyte material having good ion conductivity can be obtained. Moreover, because the raw material composition contains the element O, a sulfide solid electrolyte material whose ion conductivity is improved even more can be obtained.

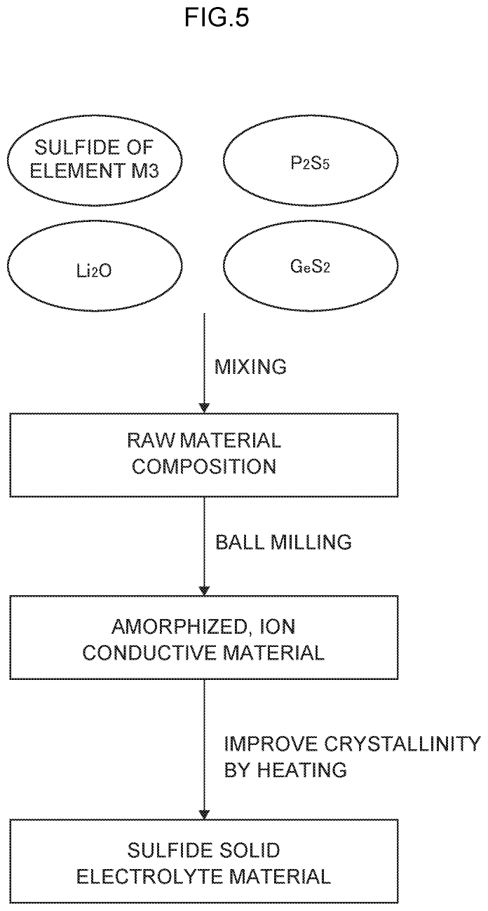

FIG. 5 is an explanatory drawing illustrating an example of the method of manufacturing a sulfide solid electrolyte material of the first embodiment. In the method of manufacturing a sulfide solid electrolyte material in FIG. 5, first, a raw material composition is prepared by mixing together Li₂S, P₂S₅, GeS₂ and a sulfide of element M₃ (e.g., Ta₂S₅, Nb₂S₅, WS₂ or the like). At this time, in order to prevent the raw material composition from deteriorating due to moisture in the air, it is preferable to prepare the raw material composition in an inert gas atmosphere. Next, ball milling is carried out on the raw material composition, and an amorphized, ion conductive material is obtained. Next, by heating the amorphized, ion conductive material and improving the crystallinity, the sulfide solid electrolyte material is obtained.

In the first embodiment, a sulfide solid electrolyte material having a high proportion of a crystal phase having a peak in the vicinity of 2θ=29.58° can be obtained, and the reason for this is described hereinafter. In the first embodiment, the amorphized, ion conductive material is synthesized all at one time, which is different than a solid phase method that is a conventional synthesizing method. Due thereto, it is thought that there is an environment in which it is easy for crystal phase A (a crystal phase having a peak in the vicinity of 2θ=29.58° that has high ion conductivity to precipitate, and, due to the heating step that is thereafter, crystal phase A can be actively precipitated, and the value of I_{B}/I_{A} can be made to be less than 1.00 which was not possible conventionally. The reason why there is an environment in which it is easy for crystal phase A to precipitate due to amorphization is not completely clear, but it is thought that there is the possibility that the solid solution region in the ion conductive material changes due to the mechanical milling, and the environment changes from an environment in which it is difficult for crystal phase A to precipitate to an environment in which it is easy for crystal phase A to precipitate.

The respective steps of the method of manufacturing a sulfide solid electrolyte material of the first embodiment are described hereinafter one-by-one.

### (1) Ion Conductive Material Synthesizing Step

First, the ion conductive material synthesizing step in the first embodiment is described. The ion conductive material synthesizing step in the first embodiment is a step of synthesizing, by mechanical milling, an amorphized, ion conductive material by using a raw material composition containing above-described element M₁, element M₂, element M₃ and element S.

The raw material composition in the first embodiment is not particularly limited provided that it contains element M₁, element M₂, element M₃ and the element S. Note that element M₁, element M₂ and element M₃ in the raw material composition are the same as those described in above “A. Sulfide Solid Electrolyte Material”.

Compounds containing element M₁ are not particularly limited, and examples thereof are elemental M₁ and sulfides of M₁. Examples of sulfides of M₁ are Li₂S, Na₂S, K₂S, MgS, CaS, ZnS and the like.

Compounds containing element M₂ are not particularly limited, and examples thereof are elemental M₂ and sulfides of M₂. Examples of sulfides of M₂ are Me₂S₃ (Me is a trivalent element, e.g., Al, B, Ga, In, Sb), MeS₂ (Me is a tetravalent element, e.g., Ge, Si, Sn, Zr, Ti, Nb), Me₂S₅ (Me is a pentavalent element, e.g., P, V), and the like.

Compounds containing element M₃ are not particularly limited, and examples thereof are elemental M₃ and sulfides of M₃. Examples of sulfides of M₃ are Ta₂S₅, Nb₂S₅, WS₂, (NH₄)₂WS₄, TaS₂, NbS₂ and the like.

Compounds containing S are not particularly limited, and may be elemental S or sulfides. Examples of the sulfides are the above-described sulfides that contain element M₁, element M₂ or element M₃.

Moreover, the raw material composition preferably has the composition [Li]₍₄₋ₓ₎[element M₃]_{y}[Ge]₍₁₋ₓ₎[P]ₓ[S]₄(x satisfies 0<x<1, y satisfies 0.010≤y≤0.040). This is because a sulfide solid electrolyte material having high ion conductivity and exhibiting excellent water resistance even in an environment in which the moisture concentration is high (e.g., a dewpoint of −6° C.) can be obtained. Note that, as described above, the composition Li₍₄₋ₓ₎Ge₍₁₋ₓ₎PₓS₄ that does not have element M₃ corresponds to the composition of a solid solution of Li₃PS₄ and Li₄GeS₄. Here, when considering a case in which the raw material composition contains Li₂S, P₂S₅ and GeS₂, the proportion of the Li₂S and the P₂S₅ for obtaining Li₃PS₄ is Li₂S:P₂S₅=75:25 on a mole basis. On the other hand, the proportion of the Li₂S and the GeS₂ for obtaining Li₄GeS₄ is Li₂S:GeS₂=66.7:33.3 on a mole basis. Therefore, it is preferable to determine the amounts of Li₂S, P₂S₅ and GeS₂ that are to be used in consideration of these proportions. Further, preferable ranges of x and y are the same as those described in above “A. Sulfide Solid Electrolyte Material”.

Moreover, the raw material composition preferably has the composition [Li]₍₄₋ₓ₎[element M₃]_{y}[Si]₍₁₋ₓ₎[P]ₓ[S]₄(x satisfies 0<x<1, y satisfies 0.010≤y≤0.040). This is because a sulfide solid electrolyte material having high ion conductivity and exhibiting excellent water resistance even in an environment in which the moisture concentration is high (e.g., a dewpoint of −6° C.) can be obtained. Note that, as described above, the composition Li₍₄₋ₓ₎Si₍₁₋ₓ₎PₓS₄ that does not have element M₃ corresponds to the composition of a solid solution of Li₃PS₄ and Li₄SiS₄. Here, when considering a case in which the raw material composition contains Li₂S, P₂S₅ and SiS₂, the proportion of the Li₂S and the P₂S₅ for obtaining Li₃PS₄ is Li₂S:P₂S₅=75:25 on a mole basis. On the other hand, the proportion of the Li₂S and the SiS₂ for obtaining Li₄SiS₄ is Li₂S:SiS₂=66.7:33.3 on a mole basis. Therefore, it is preferable to determine the amounts of Li₂S, P₂S₅ and SiS₂ that are to be used in consideration of these proportions. Further, preferable ranges of x and y are the same as those described in above “A. Sulfide Solid Electrolyte Material”.

Mechanical milling is a method of pulverizing a sample while applying mechanical energy thereto. In the first embodiment, the amorphized, ion conductive material is synthesized by applying mechanical energy to the raw material composition. Examples of such mechanical milling are vibration milling, ball milling, turbo milling, mechano-fusion, disk milling and the like, and, thereamong, vibration milling and ball milling are preferable.

The conditions of the vibration milling are not particularly limited provided that the amorphized, ion conductive material can be obtained thereby. The vibration amplitude of the vibration milling is, for example, within the range of 5 mm˜15 mm, and therein, is preferably within the range of 6 mm˜10 mm. The vibration frequency of the vibration milling is, for example, within the range of 500 rpm˜2000 rpm, and therein, is preferably within the range of 1000 rpm˜1800 rpm. The fill rate of the sample in the vibration milling is, for example, within the range of 1 vol %˜80 vol %, and, therein, is preferably within the range of 5 vol %˜60 vol %, and particularly preferably within the range of 10 vol %˜50 vol %. Further, a vibrator (e.g., a vibrator made of aluminum) is preferably used in the vibration milling.

The conditions of the ball milling are not particularly limited provided that the amorphized, ion conductive material can be obtained thereby. Generally, the greater the number of revolutions, the faster the speed of generating the ion conductive material, and, the longer the processing time, the higher the conversion rate from the raw material composition into the ion conductive material. The number of revolutions of the weighing table at the time of carrying out planetary ball milling is, for example, within the range of 200 rpm˜500 rpm, and therein, is preferably within the range of 250 rpm˜400 rpm. Further, the processing time when carrying out planetary ball milling is, for example, within the range of 1 hour˜100 hours, and, therein, is preferably within the range of 1 hour˜70 hours.

In the first embodiment, it is preferable to synthesize the amorphized, ion conductive material such that there is an environment in which it is easy for the crystal phase having a peak in the vicinity of 2θ=29.58° to precipitate.

### (2) Heating Step

The heating step in the first embodiment is a step of obtaining the sulfide solid electrolyte material by heating the above-described amorphized, ion conductive material.

In the first embodiment, an improvement in the crystallinity is devised by heating the amorphized, ion conductive material. By carrying out heating, crystal phase A (a crystal phase having a peak in the vicinity of 2θ=29.58° that has high ion conductivity can be actively precipitated, and the value of I_{B}/I_{A} can be made to be less than 1.00 which was conventionally not possible.

The heating temperature in the first embodiment is not particularly limited provided that it is a temperature by which the desired sulfide solid electrolyte material can be obtained, and is preferably a temperature that is greater than or equal to the crystallization temperature of crystal phase A (a crystal phase having a peak in the vicinity of 2θ=29.58°). Specifically, the heating temperature is preferably 300° C. or more, and more preferably 350° C. or more, and even more preferably 400° C. or more, and particularly preferably 450° C. or more. On the other hand, the heating temperature is preferably 1000° C. or less, and more preferably 700° C. or less, and even more preferably 650° C. or less, and particularly preferably 600° C. or less. Further, the heating time is preferably adjusted appropriately so as to obtain the desired sulfide solid electrolyte material. From the standpoint of preventing oxidation, it is preferable to carry out the heating in the first embodiment in an inert gas atmosphere or in a vacuum. Further, because the sulfide solid electrolyte material obtained by the first embodiment has the same contents as described in above “A. Sulfide Solid Electrolyte Material, 1. First Embodiment”, description thereof is omitted here.

### 2. Second Embodiment

The method of manufacturing a sulfide solid electrolyte material of the second embodiment is a method of manufacturing the sulfide solid electrolyte material described in “A. Sulfide Solid Electrolyte Material, 2. Second Embodiment”, and has the feature of including: an ion conductive material synthesizing step of synthesizing, by mechanical milling, an amorphized, ion conductive material by using a raw material composition containing above-described element M₁, element M₂ₐ, element M_{2b}, element M₃ and element S; and a heating step of obtaining the sulfide solid electrolyte material by heating the amorphized, ion conductive material.

In accordance with the second embodiment, by carrying out amorphization in the ion conductive material synthesizing step and thereafter carrying out heating, a sulfide solid electrolyte material in which octahedrons O, tetrahedrons T₁ and tetrahedrons T₂ have a predetermined crystal structure (a three-dimensional structure) can be obtained. Therefore, a sulfide solid electrolyte material having good ion conductivity can be obtained.

The ion conductive material synthesizing step and the heating step in the second embodiment are basically the same as the contents described in above “C. Method of Manufacturing Sulfide Solid Electrolyte Material, 1. First Embodiment”, and therefore, description thereof is omitted here. It is preferable to set the various conditions such that the desired sulfide solid electrolyte material is obtained.

Note that the present disclosure is not limited to the above-described embodiments. The above embodiments are illustrative, and all forms that have substantially the same structures as, and exhibit similar operations and effects as, the technical concepts put forth in the claims of the present disclosure are included in the technical scope of the present disclosure.

### EXAMPLES

The present disclosure is described more concretely hereinafter by way of Examples.

### Comparative Example 1

Lithium sulfide (Li₂S, manufactured by Mitsuwa Chemicals, Co., Ltd.), phosphorus pentasulfide (P₂S₅, manufactured by Sigma-Aldrich Co. LLC) and germanium sulfide (GeS₂, manufactured by Japan Pure Chemical Co., Ltd.) are used as the starting materials. Powders of these are mixed together in a mortar in a proportion of 0.3925 g of Li₂S, 0.3027 g of P₂S₅, and 0.3048 g of GeS₂, and a raw material composition is obtained.

Next, 1 g of the raw material composition is placed in a pot (45 ml) made of zirconia together with zirconia balls (18 balls of 10 mm diameter), and the pot is completely sealed (an argon atmosphere). This pot is attached to a planetary ball mill device (P7 manufactured by Fritsch Japan Co., Ltd.), and mechanical milling is carried out by ball mill processing for 40 hours at a number of revolutions of the weighing table of 380 rpm. An amorphized, ion conductive material is thereby obtained.

Next, the obtained ion conductive material is placed in a container made of aluminum, and the temperature is raised from room temperature to 550° C. over 3 hours in an Ar gas flow (80 mL/min), and thereafter, firing is carried out for 8 hours. The sulfide solid electrolyte material having the composition shown in Table 1 is thereby obtained.

### Example 1

A sulfide solid electrolyte material is obtained in the same way as in Comparative Example 1 except that lithium sulfide (Li₂S, manufactured by Mitsuwa Chemicals, Co., Ltd.), phosphorus pentasulfide (P₂S₅, manufactured by Sigma-Aldrich Co. LLC), germanium sulfide (GeS₂, manufactured by Japan Pure Chemical Co., Ltd.), tantalum sulfide (TaS₂, manufactured by Japan Pure Chemical Co., Ltd.) and sulfur (S, manufactured by Japan Pure Chemical Co., Ltd.) are used as the starting materials, and the amounts of these respective starting materials are adjusted such that the composition is the composition shown in Table 1.

### Example 2

A sulfide solid electrolyte material is obtained in the same way as in Comparative Example 1 except that lithium sulfide (Li₂S, manufactured by Mitsuwa Chemicals, Co., Ltd.), phosphorus pentasulfide (P₂S₅, manufactured by Sigma-Aldrich Co. LLC), germanium sulfide (GeS₂, manufactured by Japan Pure Chemical Co., Ltd.), niobium sulfide (NbS₂, manufactured by Japan Pure Chemical Co., Ltd.) and sulfur (S, manufactured by Japan Pure Chemical Co., Ltd.) are used as the starting materials, and the amounts of these respective starting materials are adjusted such that the composition is the composition shown in Table 1.

### Example 3

A sulfide solid electrolyte material is obtained in the same way as in Comparative Example 1 except that lithium sulfide (Li₂S, manufactured by Mitsuwa Chemicals, Co., Ltd.), phosphorus pentasulfide (P₂S₅, manufactured by Sigma-Aldrich Co. LLC), germanium sulfide (GeS₂, manufactured by Japan Pure Chemical Co., Ltd.), tungsten sulfide (WS₂, manufactured by Japan Pure Chemical Co., Ltd.) and sulfur (S, manufactured by Japan Pure Chemical Co., Ltd.) are used as the starting materials, and the amounts of these respective starting materials are adjusted such that the composition is the composition shown in Table 1.

### Evaluation 1

### X-ray Diffraction Measurement

X-ray diffraction (XRD) measurement is carried out by using the sulfide solid electrolyte materials obtained in Examples 1 through 3 and Comparative Example 1. The XRD measurement is carried out on powder samples in an inert atmosphere and by using a CuKα beam. A single-phase sulfide solid electrolyte material is obtained in Comparative Example 1. The positions of the peaks are 2θ=17.38°, 20.18°, 20.44°, 23.56°, 23.96°, 24.93°, 26.96°, 29.07º, 29.58°, 31.71°, 32.66°, 33.39°. It is thought that these peaks are peaks of crystal phase A having high ion conductivity. Note that peaks of 2θ=27.33°±0.50° that are peaks of crystal phase B having low ion conductivity are not recognized. Further, it is recognized that Examples 1 through 3 have diffraction patterns similar to Comparative Example 1.

### X-ray Structural Analysis

The crystal structure of the sulfide solid electrolyte material obtained in Comparative Example 1 is identified by X-ray structural analysis. The crystal system/crystallographic group is determined by a direct method on the basis of the diffraction pattern obtained by XRD, and thereafter, the crystal structure is defined by the real space method. As a result, it is confirmed that the sulfide solid electrolyte material has a crystal structure such that that of above-described FIG. 2, FIG. 3. Namely, there is a crystal structure in which the tetrahedrons T₁ (GeS₄ tetrahedrons and PS₄ tetrahedrons) and the octahedrons O (LiS₆ octahedrons) share edges, and the tetrahedrons T₂ (PS₄ tetrahedrons) and the octahedrons O (LiS₆ octahedrons) share vertices. Further, because Examples 1 through 3 have diffraction patterns that are similar to Comparative Example 1 as described above, it is confirmed that similar crystal structures are formed in Examples 1 through 3 as well.

### Measurement of Generated Amount of H₂S

By using the sulfide solid electrolyte materials obtained in Examples 1 through 3 and Comparative Example 1, the amount of H₂S generated in an environment of a dewpoint of −6° C. is measured. First, a 1.5 L desiccator is placed within a dry air glove box of a dewpoint of −6° C., and 5 mg of the sample is weighed-out and placed in an aluminum container, and this aluminum container with the sample therein is placed in the desiccator. The cover of the desiccator is closed in a state in which the fan is rotated, and the sample is exposed for one hour to an environment of a dewpoint of −6° C. The H₂S that is generated at this time is measured by a sensor (manufacturer: ToxiRAEPro, model number: 0-100 ppm, measurement mode: none) and is calculated as the amount of H₂S generated per unit specific surface area. The results are shown in Table 1.

### Measurement of Li Ion Conductivity

The Li ion conductivity at 25° C. is measured by using the sulfide solid electrolyte materials obtained in Examples 1 through 3 and Comparative Example 1. First, within a glove box of an argon atmosphere, an appropriate amount of the sample is weighed out and placed in a polyethylene terephthalate tube (a PET tube, inner diameter 10 mm, outer diameter 30 mm, height 20 mm), and the sample is nipped from above and below by powder molding jigs formed from carbon tool steel S45C anvils. Next, by using a uniaxial press machine (P-6 manufactured by Riken Seiki Co., Ltd.), the sample is pressed at a surface pressure of 6 MPa (a molding pressure of approximately 110 MPa), and a pellet of a diameter of 10 mm and an arbitrary thickness is molded. Next, 13 mg˜15 mg of a gold powder (manufactured by The Nilaco Corporation, tree-like, particle diameter approximately 10 μm) is placed on each of the both surfaces of the pellet, and is dispersed uniformly on the surfaces of the pellet, and molding is carried out at a surface pressure of 30 MPa (a molding pressure of approximately 560 MPa). Thereafter, the obtained pellet is placed in a sealed electrochemical cell that can maintain an argon atmosphere.

An impedance/gain phase analyzer (Solartron 1260) manufactured by Solartron is used as the FRA (Frequency Response Analyzer), and a compact environment tester (Especorp, SU-241, −40° C.˜150° C.) is used as the constant temperature device. Measurement is started from a high frequency region under the conditions of AC voltage of 10 mV˜1000 mV, frequency range of 1 Hz˜10 MHz, cumulative time 0.2 seconds, and temperature of 23° C. Zplot is used as the measurement software, and Zview is used as the analysis software. The obtained results are shown in Table 1.

TABLE 1

| | | | | generated | |
|---|---|---|---|---|---|
| | | | M₃/M₂ | amount of | ion |
| | | | M₃/(M₂ₐ + | H₂S | conductivity |
| | composition | I_{B}/I_{A} | M_{2b}) | (cc/m²) | (mS/cm) |
| Comparative | Li_{3.45}Ge_{0.45}P_{0.55}S₄ | 0 | — | 26.5 | 10.6 |
| Example 1 | | | | | |
| Comparative | Li_{3.45}Ta_{0.0225}Ge_{0.4275}P_{0.55}S₄ | 0 | 0.23 | 14.0 | 8.9 |
| Example 2 | | | | | |
| Comparative | Li_{3.45}Nb_{0.0225}Ge_{0.4275}P_{0.55}S₄ | 0 | 0.23 | 6.8 | 8.2 |
| Example 3 | | | | | |
| Comparative | Li_{3.45}W_{0.0225}Ge_{0.4275}P_{0.55}S₄ | 0 | 0.23 | 6.9 | 7.3 |
| Example 4 | | | | | |

As shown in Table 1, it can be understood that Examples 1 through 3 that contain element M₁, element M₂, element M₃ and the element S exhibit excellent water resistance even in an environment in which the moisture concentration is high (a dewpoint of −6° C.), as compared with Comparative Example 1 that does not contain element M₃.

An object of the present disclosure is to provide a sulfide solid electrolyte material that exhibits excellent water resistance even in an environment in which the moisture concentration is high (e.g., a dewpoint of −6° C.), a method of manufacture thereof, and a battery that uses the sulfide solid electrolyte material.

Means for addressing the above topic include the following aspects.

A first aspect of the present disclosure is a sulfide solid electrolyte material, comprising an element M₁, an element M₂, an element M₃ and an element S, wherein: the element M₁ is at least one selected from the group consisting of Li, Na, K, Mg, Ca and Zn, and contains at least one of Li or Na; the element M₂ is at least one selected from the group consisting of P, Sb, Si, Ge, Sn, B, Al, Ga, In, Ti, Zr and V, and contains at least P; the element M₃ is at least one selected from transition elements of group 3 to group 12; and the sulfide solid electrolyte material has a peak at a position of 2θ=29.58°±0.50°, in X-ray diffraction measurement using a CuKα beam, or the sulfide solid electrolyte material does not have a peak at a position of 2θ=27.33°±0.50°, in X-ray diffraction measurement using a CuKα beam, or in a case in which the sulfide solid electrolyte material has a peak at a position of 2θ=27.33°±0.50°, if a diffracted intensity of the peak at 2θ=29.58°±0.50° is I_{A} and a diffracted intensity of the peak at 2θ=27.33°±0.50° is I_{B}, a value of I_{B}/I_{A} is less than 1.00.

A second aspect of the present disclosure is the sulfide solid electrolyte material of the first aspect, wherein a proportion (M₃/M₂) of a content of element M₃ with respect to a content of element M₂ is from 0.010 to 0.040.

A third aspect of the present disclosure is the sulfide solid electrolyte material of the first or second aspect, wherein the element M₃ includes at least one selected from transition elements of group 5 and group 6.

A fourth aspect of the present disclosure is the sulfide solid electrolyte material of the third aspect, wherein the element M₃ includes at least one selected from the group consisting of Ta, Nb and W.

A fifth aspect of the present disclosure is the sulfide solid electrolyte material of the fourth aspect, wherein the element M₃ includes at least one selected from the group consisting of Nb and W.

A sixth aspect of the present disclosure is a sulfide solid electrolyte material, comprising octahedrons O structured from an element M₁ and an element S, tetrahedrons T₁ structured from an element M₂ₐ and the element S, and tetrahedrons T₂ structured from the element S and at least one selected from the group consisting of an element M_{2b} and an element M₃, and having, as a main body, a crystal structure in which the tetrahedrons T₁ and the octahedrons O share edges, and the tetrahedrons T₂ and the octahedrons O share vertices, wherein: the element M₁ is at least one selected from the group consisting of Li, Na, K, Mg, Ca and Zn, and contains at least one of Li or Na; and each of the element M₂ₐ and the element M_{2b} is independently at least one selected from the group consisting of P, Sb, Si, Ge, Sn, B, Al, Ga, In, Ti, Zr and V, and contain at least P; and the element M₃ is at least one selected from transition elements of group 3 to group 12.

The seventh aspect of the present disclosure is the sulfide solid electrolyte material of the sixth aspect, wherein a proportion (M₃/(M₂ₐ+M_{2b})) of a content of the element M₃ with respect to a total content of the element M₂ₐ and the element M_{2b} is from 0.010 to 0.040.

The eighth aspect of the present disclosure is the sulfide solid electrolyte material of the sixth or seventh aspect, wherein the element M₃ includes at least one selected from transition elements of group 5 and group 6.

The ninth aspect of the present disclosure is the sulfide solid electrolyte material of the eighth aspect, wherein the element M₃ includes at least one selected from the group consisting of Ta, Nb and W.

The tenth aspect of the present disclosure is the sulfide solid electrolyte material of the ninth aspect, wherein the element M₃ includes at least one selected from the group consisting of Nb and W.

An eleventh aspect of the present disclosure is a battery, comprising a positive electrode active material layer containing a positive electrode active material, a negative electrode active material layer containing a negative electrode active material, and an electrolyte layer formed between the positive electrode active material layer and the negative electrode active material layer, wherein at least one of the positive electrode active material layer, the negative electrode active material layer or the electrolyte layer contains the sulfide solid electrolyte material of the first aspect.

An twelfth aspect of the present disclosure is a battery, comprising a positive electrode active material layer containing a positive electrode active material, a negative electrode active material layer containing a negative electrode active material, and an electrolyte layer formed between the positive electrode active material layer and the negative electrode active material layer, wherein at least one of the positive electrode active material layer, the negative electrode active material layer or the electrolyte layer contains the sulfide solid electrolyte material of the sixth aspect.

A thirteenth aspect of the present disclosure is a method of manufacturing the sulfide solid electrolyte material of the first aspect, the method comprising: synthesizing, by mechanical milling, an amorphized, ion conductive material by using a raw material composition containing the element M₁, the element M₂, the element M₃ and the element S; and obtaining the sulfide solid electrolyte material by heating the amorphized, ion conductive material.

A fourteenth aspect of the present disclosure is a method of manufacturing the sulfide solid electrolyte material of the sixth aspect, the method comprising: synthesizing, by mechanical milling, an amorphized, ion conductive material by using a raw material composition containing the element M₁, the element M₂ₐ, the element M_{2b}, the element M₃ and the element S; and obtaining the sulfide solid electrolyte material by heating the amorphized, ion conductive material.

In accordance with the present disclosure, there are provided a sulfide solid electrolyte material that exhibits excellent water resistance even in an environment in which the moisture concentration is high (e.g., a dewpoint of −6° C.), a method of manufacture thereof, and a battery that uses the sulfide solid electrolyte material.

What is claimed is:

1. A sulfide solid electrolyte material, comprising an element M₁, an element M₂, an element M₃ and an element S, wherein:
the element M₁ is at least one selected from the group consisting of Li, Na, K, Mg, Ca and Zn, and contains at least one of Li or Na;
the element M₂ is at least one selected from the group consisting of P, Sb, Si, Ge, Sn, B, Al, Ga, In, Ti, Zr and V, and contains at least P;
the element M₃ is at least one selected from transition elements of group 3 to group 12; and
the sulfide solid electrolyte material has a peak at a position of 2θ=29.58°±0.50°, in X-ray diffraction measurement using a CuKα beam, or
the sulfide solid electrolyte material does not have a peak at a position of 2θ=27.33°±0.50°, in X-ray diffraction measurement using a CuKα beam, or
in a case in which the sulfide solid electrolyte material has a peak at a position of 2θ=27.33°±0.50°, if a diffracted intensity of the peak at 2θ=29.58°±0.50° is I_{A} and a diffracted intensity of the peak at 2θ=27.33°±0.50° is I_{B}, a value of I_{B}/I_{A} is less than 1.00.

2. The sulfide solid electrolyte material of claim 1, wherein a proportion (M₃/M₂) of a content of element M₃ with respect to a content of element M₂ is from 0.010 to 0.040.

3. The sulfide solid electrolyte material of claim 1, wherein the element M₃ includes at least one selected from transition elements of group 5 and group 6.

4. The sulfide solid electrolyte material of claim 3, wherein the element M₃ includes at least one selected from the group consisting of Ta, Nb and W.

5. The sulfide solid electrolyte material of claim 4, wherein the element M₃ includes at least one selected from the group consisting of Nb and W.

6. A sulfide solid electrolyte material, comprising octahedrons O structured from an element M₁ and an element S, tetrahedrons T₁ structured from an element M₂ₐ and the element S, and tetrahedrons T₂ structured from the element S and at least one selected from the group consisting of an element M_{2b} and an element M₃, and having, as a main body, a crystal structure in which the tetrahedrons T₁ and the octahedrons O share edges, and the tetrahedrons T₂ and the octahedrons O share vertices, wherein:
the element M₁ is at least one selected from the group consisting of Li, Na, K, Mg, Ca and Zn, and contains at least one of Li or Na; and
each of the element M₂ₐ and the element M_{2b} is independently at least one selected from the group consisting of P, Sb, Si, Ge, Sn, B, Al, Ga, In, Ti, Zr and V, and contain at least P; and
the element M₃ is at least one selected from transition elements of group 3 to group 12.

7. The sulfide solid electrolyte material of claim 6, wherein a proportion (M₃/(M₂ₐ+M_{2b})) of a content of the element M₃ with respect to a total content of the element M₂ₐ and the element M_{2b} is from 0.010 to 0.040.

8. The sulfide solid electrolyte material of claim 6, wherein the element M₃ includes at least one selected from transition elements of group 5 and group 6.

9. The sulfide solid electrolyte material of claim 8, wherein the element M₃ includes at least one selected from the group consisting of Ta, Nb and W.

10. The sulfide solid electrolyte material of claim 9, wherein the element M₃ includes at least one selected from the group consisting of Nb and W.

11. A battery, comprising a positive electrode active material layer containing a positive electrode active material, a negative electrode active material layer containing a negative electrode active material, and an electrolyte layer formed between the positive electrode active material layer and the negative electrode active material layer,
wherein at least one of the positive electrode active material layer, the negative electrode active material layer or the electrolyte layer contains the sulfide solid electrolyte material of claim 1.

12. A battery, comprising a positive electrode active material layer containing a positive electrode active material, a negative electrode active material layer containing a negative electrode active material, and an electrolyte layer formed between the positive electrode active material layer and the negative electrode active material layer,
wherein at least one of the positive electrode active material layer, the negative electrode active material layer or the electrolyte layer contains the sulfide solid electrolyte material of claim 6.

13. A method of manufacturing the sulfide solid electrolyte material of claim 1, the method comprising:
synthesizing, by mechanical milling, an amorphized, ion conductive material by using a raw material composition containing the element M₁, the element M₂, the element M₃ and the element S; and
obtaining the sulfide solid electrolyte material by heating the amorphized, ion conductive material.

14. A method of manufacturing the sulfide solid electrolyte material of claim 6, the method comprising:
synthesizing, by mechanical milling, an amorphized, ion conductive material by using a raw material composition containing the element M₁, the element M₂ₐ, the element M_{2b}, the element M₃ and the element S; and
obtaining the sulfide solid electrolyte material by heating the amorphized, ion conductive material.
